(19) United States
(12) Patent Application Publication
(10) Pub. No.: US 2011/0213549 A1
(43) Pub. Date: Sep. 1, 2011

(54) LOCATION BASED VIRTUAL TOUR

(76) Inventor: MARIA E. HALLAS, Potomac, MD (US)

(21) Appl. No.: 12/907,254

(22) Filed: Oct. 19, 2010

Related U.S. Application Data
(60) Provisional application No. 61/309,198, filed on Mar. 1, 2010.

(51) Int. Cl. G01C 21/00

(52) U.S. Cl. 701/201; 701/207

(57) ABSTRACT

The geographic location of a mobile device is determined. Tour information is accessed by the mobile device based upon, at least in part, the determined geographic location. The tour information is rendered on the mobile device based upon, at least n part, the determined geographic location.

### CROSS-REFERENCE TO RELATED APPLICATION

This application claims the benefit of U.S. provisional patent application Ser. No. 61/309,198, filed on 1 Mar. 2010, the entire disclosure of which is incorporated herein by reference.

### TECHNICAL FIELD

The present disclosure generally pertains to mobile devices, and more particularly relates to providing location based information.

### BACKGROUND

Often while travelling an individual may wish to see the sights of city that she is in. Typically, such an experience is available by taking part in a guided tour, or by obtaining various tourist information and maps. However, guided tours may often involve multiple-hour time commitment and may include visiting sites in which the individual may not have a particular interest. Similarly, tourist brochures and maps may often only include the location of selected sites and may not include detailed information about all of the sites and/or information in which the individual may be interested. As such, the primary options for sight-seeing may often not be conducive to a spontaneous desire to see the sights or when an individual is on a constrained time budget.

### SUMMARY OF THE DISCLOSURE

According to an implementation, a computer implemented method includes determining a geographic location of a mobile device. Tour information is accessed by the mobile device based upon, at least in part, the determined geographic location. The tour information is rendered on the mobile device based upon, at least in part, the determined geographic location.

One or more of the following features may be included. Accessing tour information may include accessing tour information via a wireless network. Accessing tour information may include accessing tour information stored on a local storage device. The tour information may include information relevant to one or more landmarks associated with the determined geographic location.

Rendering the tour information may include providing directions to one or more landmarks based upon, at least in part, the determined geographic location. Rendering the tour information may include providing one or more of: video output, audio output, text-based output.

According to another implementation, a computer program product resides on a computer readable medium having a plurality of instructions stored on it. When executed by a processor, the instructions cause the processor to perform operations including determining a geographic location of a mobile device. Instructions are further included to cause the processor to access, by the mobile device, tour information based upon, at least in part, the determined geographic location. The tour information is rendered on the mobile device based upon, at least in part, the determined geographic location.

One or more of the following features may be included. The instructions for accessing tour information may include instructions for accessing tour information via a wireless network. The instructions for accessing tour information may include instructions for accessing tour information stored on a local storage device. The tour information may include information relevant to one or more landmarks associated with the determined geographic location.

The instructions for rendering the tour information may include instructions for providing directions to one or more landmarks based upon, at least in part, the determined geographic location. The instructions for rendering the tour information may include instructions fore providing one or more of: video output, audio output, text-based output.

According to yet another implementation, a system includes a processor and a memory coupled with the processor. A first software module is executable by the processor and the memory. The first software module is configured to determine a geographic location of a mobile device. A second software module is also executable by the processor and the memory. The second software module is configured to access, by the mobile device, tour information based upon, at least in part, the determined geographic location. A third software module is also executable by the processor and the memory. The third software module is configured to render, on the mobile device, the tour information based upon, at least in part, the determined geographic location.

One or more of the following features may be included. The second software module, configured to access tour information, may be configured to access tour information via a wireless network. The second software module, configured to access tour information, may be configured to access tour information stored on a local storage device. The tour information may include information relevant to one or more landmarks associated with the determined geographic location.

The third software module, configured to render the tour information, may be configured to provide directions to one or more landmarks based upon, at least in part, the determined geographic location. The third software module, configured to render the tour information, may be configured to provide one or more of: video output, audio output, text-based output.

The details of one or more implementations are set forth in the accompanying drawings and the description below. Other features and advantages will become apparent from the description, the drawings, and the claims

### BRIEF DESCRIPTION OF THE DRAWINGS

FIG. 1 diagrammatically depicts a virtual tour process coupled to a distributed computing network.

FIG. 2. is a flowchart of a process executed by the virtual tour process of FIG. 1.

FIG. 3 is a diagrammatic view of a user interface generated by the virtual tour process of FIG. 1.

FIG. 4 is a diagrammatic view of a user interface generated by the virtual tour process of FIG. 1.

FIG. 5 is a diagrammatic view of a user interface generated by the virtual tour process of FIG. 1.

### DETAILED DESCRIPTION OF PREFERRED EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium include a computer-readable storage medium, which may be, for example, but is not limited to, an electronic, magnetic, optical, electromagnetic, infrared, or semiconductor system, apparatus, a device, or any suitable combination of the foregoing. Exemplary computer readable storage medium may include, but is not limited to, a portable computer diskette, a hard disk, a solid state disc drive, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on a single computing device, e.g., as a stand-alone software package, and or may be at least partly executed on multiple computing devices that may be remote to one another. In the latter scenario, remote computing devices may be connected to one another through a local area network (LAN) or a wide area network (WAN), or the connection may be made to one or more remote computing devices (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

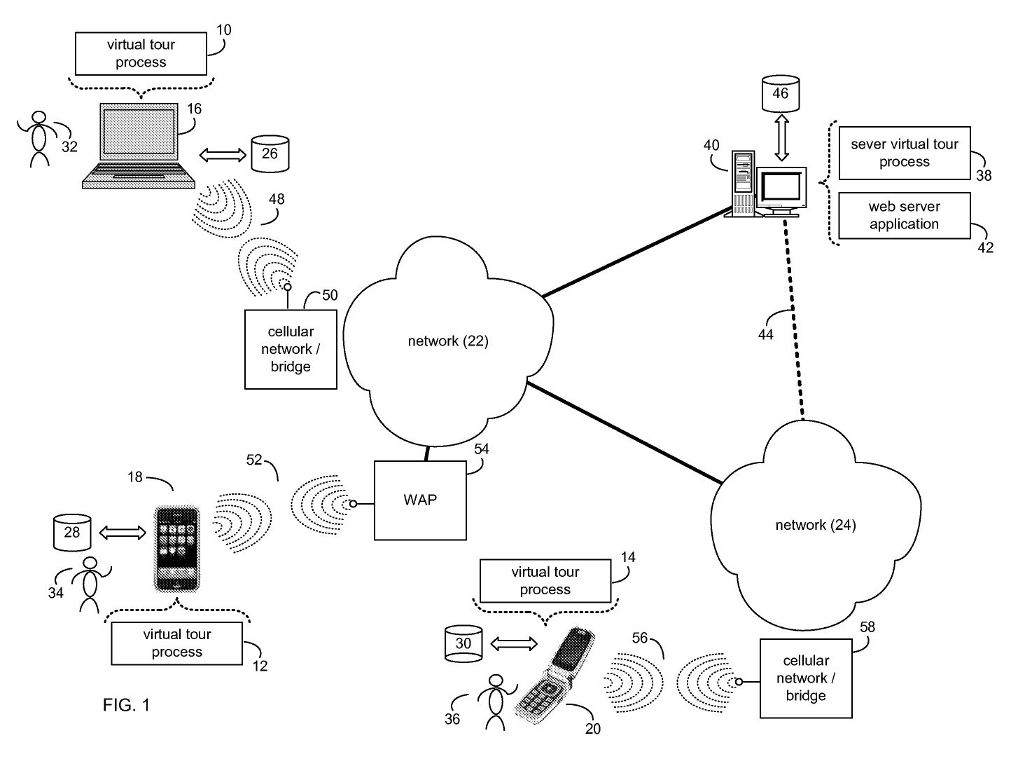

Referring to FIG. 1, there is shown a virtual tour process (e.g., virtual tour process 10, 12, 14) that may reside on and may be executed by a mobile device (e.g., mobile device 16, 18, 20). Examples of mobile devices may include, but are not limited to, netbook computer 16 (e.g., which may include a cellular modem), smart phone 18, and cellular telephone 20, purpose specific mobile devices, and the like. Mobile devices 16, 18, 20 may be capable of being connected to a data network (e.g., network 22, network 24) via various wireless communication channels (e.g., Wi-Fi communication channel, Bluetooth communication channel, cellular communication channel, or the like). Mobile devices 16, 18, 20 may each execute an operating system, examples of which may include but are not limited to Android, iPhone OS, WebOS, etc., or a custom operating system (Android is a trademark of Google Inc. in the United States, other countries, or both; iPhone OS is a trademark of Apple Inc. in the United States, other countries, or both; WebOS is a trademark of Palm, Inc. in the United States, other countries, or both).

As will be discussed below in greater detail, the virtual tour process (e.g., virtual tour process 10, 12, 14) may determine a geographic location of a mobile device. Virtual tour process 10, 12, 14 may allow tour information to be accessed by the mobile device based upon, at least in part, the determined geographic location. Further, virtual tour process 10, 12, 14, may render tour information on the mobile device based upon, at least in part, the determined geographic location.

The instruction sets and subroutines of virtual tour process 10, 12, 14 (which may include one or more software modules) which may be stored on storage devices 26, 28, 30 (respectively) coupled to mobile devices 16, 18, 20 (respectively), may be executed by one or more processors (not shown) and one or more memory modules (not shown) incorporated into mobile devices 16, 18, 20 (respectively). Storage devices 26, 28, 30 may include but are not limited to: hard disk drives; solid state drives, random access memories (RAM), read-only memories (ROM), compact flash (CF) storage devices, secure digital (SD) storage devices, a memory stick storage devices, tape drives, optical drives, and the like.

The virtual tour process (e.g., virtual tour process 10, 12, 14) may allow a user (e.g., user 32, 34, 36) to access tour information based upon, at least in part, a geographic location of a mobile device (e.g., mobile device 16, 18, 20). In some embodiments, the virtual tour process (e.g., virtual tour process 10, 12, 14) may interact with a remote virtual tour process (e.g., server virtual tour process 38), to allow user 32, 34, 36 to access tour information. Accordingly, server virtual tour process 38 may include a library of tour information, e.g., which may be accessed by virtual tour process 10, 12, 14. Additionally/alternatively, virtual tour process 10, 12, 14 may include a web browser, which may access server virtual tour process 38 (e.g., via web server application 42, residing on server computer 40). In such an embodiment, one or more of determining a geographic location of the mobile device and accessing tour information may be carried out by server virtual tour information.

Server virtual tour process 38 may reside on a server computer (e.g., server computer 40), which may be connected to network 22 (e.g., the Internet or a local area network). Examples of server computer 40 may include, but are not limited to: a personal computer, a server computer, a series of server computers, a mini computer, and a mainframe computer. Server computer 40 may be a web server (or a series of servers) running a network operating system, examples of which may include but are not limited to: Microsoft® Windows® XP Server; Novell® NetWare®; or Red Hat® Linux®, for example (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both), for example.

Server computer 40 may execute web server application 42, examples of which may include but are not limited to: Microsoft IIS, Novell Webserver™, or Apache® Webserver, that allows for HTTP (i.e., HyperText Transfer Protocol) access to server computer 40 via network 22 (Webserver is a trademark of Novell Corporation in the United States, other countries, or both; and Apache is a registered trademark of Apache Software Foundation in the United States, other countries, or both), hosting of one or more web pages and/or web sites, and the like. Network 22 may be connected to one or more secondary networks (e.g., network 24), examples of which may include but are not limited to: a local area network; a wide area network; or an intranet, for example. Additionally/alternatively, server computer 40 may be directly coupled to network 24 (e.g., as indicated by phantom line 44)

The instruction sets and subroutines of server virtual tour process 38, which may include one or more software modules, and which may be stored on storage device 46 coupled to server computer 40, may be executed by one or more processors (not shown) and one or more memory modules (not shown) incorporated into server computer 40. Storage device 46 may include but is not limited to: a hard disk drive; a solid state drive, a tape drive; an optical drive; a RAID array; a random access memory (RAM); and a read-only memory (ROM).

The various mobile devices may be capable of being directly or indirectly coupled to network 22 (or network 24). For example, netbook computer 16 is shown coupled to network 22 via wireless communication channel 48 established between netbook computer 16 and cellular network/bridge 50. Similarly, a smart phone 18 may be wirelessly coupled to network 22 (or network 24) via wireless communication channel 52 established between smart phone 18 and wireless access point 54 (i.e., WAP), which may be coupled to network 22. WAP 54 may be, for example, an IEEE 802.11a, 802.11b, 802.11g, Wi-Fi, and/or Bluetooth device that is capable of establishing the wireless communication channel between the smart phone and the WAP. Cellular telephone 20 is shown wirelessly coupled to network 24 via wireless communication channel 56 established between cellular telephone 20 and cellular network/bridge 58, which is shown directly coupled to network 24.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the purpose of the following description, virtual tour process 10, executed on mobile device 16, will generally be discussed. However, this should not be construed as a limitation of the present disclosure, as other virtual tour processes (e.g., virtual tour process 12, 14) executed on other mobile devices (e.g., mobile devices 18, 20) may be equally utilized.

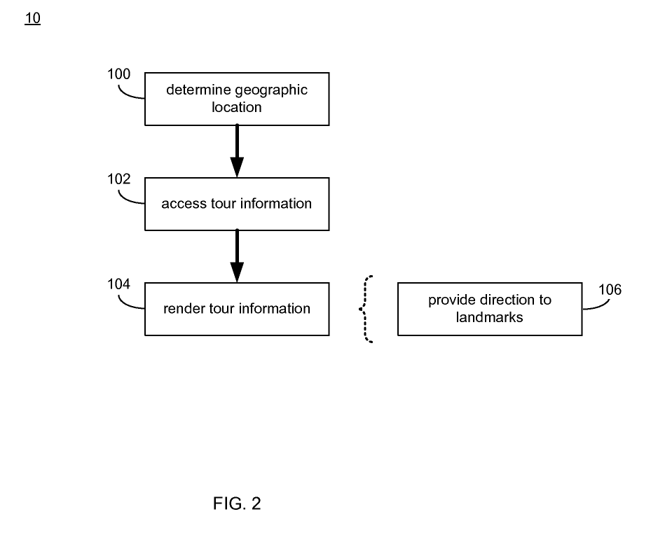

As dicussed above, and referring also to FIG. 2, virtual tour process 10 may determine 100 a geographic location of a movile device. Tour information may be accessed 102 by the mobile device based upon, at least in part, the determined 100 geographic location. Virtual tour process 10 may further render 104 the tour information on the mobile device based upon, at least in part, the determined 100 geographic location.

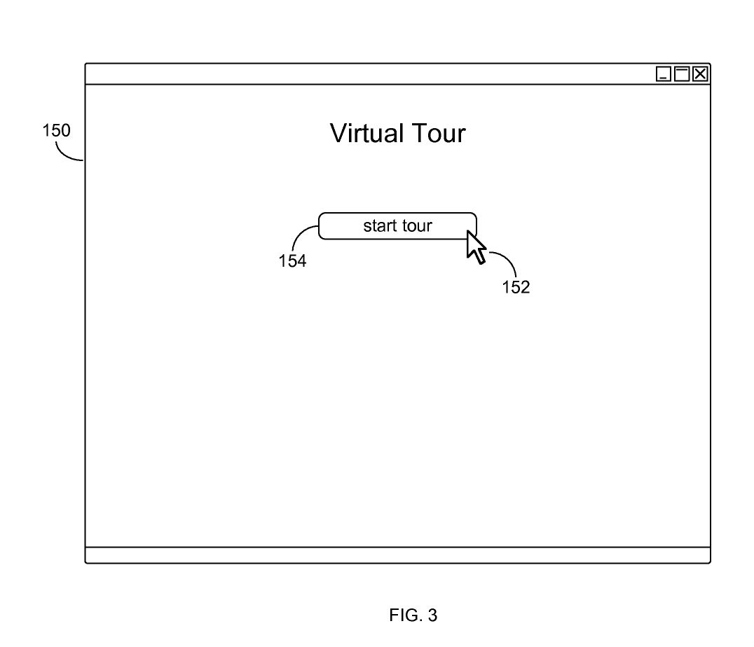

For example, user 32 may have mobile device 16 on her person, and may be walking through the North End section of Boston, Mass. User 32 may wish to discover what interesting or historic sights may be nearby. Accordingly, and referring also to FIG. 3, via user interface 150 rendered on mobile device 16, user 32 may select (e.g., via onscreen pointer 152, which may be controlled by a pointing device such as a track-pad, touch screen, or the like) “start tour” icon 154. While the specific example of a user interface including an icon-based interaction is shown, it will be appreciated that any conventional mobile device user interface may equally be utilized, depending upon design criteria and user preference. As such, the particular described user interface should be understood as an exemplary implementation, and not a limitation of the present disclosure.

In response to user 32 selecting virtual tour icon 154, virtual tour process 10 may determine 100 the geographic location (e.g., the corner of Hull St. and Salem St. in Boston's North End) of mobile device 16. The geographic location of mobile device 16 may include, for example, location coordinates determined 100 via a global positioning system (GPS) included within mobile device 16, via triangulation (or similar location technique) utilizing wireless signals (e.g., cellular communication channel), or the like. Additionally/alternatively, the geographic location of mobile device 16 may be determined 100 by a device other than mobile device 16. For example, the geographic location of mobile device 16 may be determined 100 by a cellular network/transmission system. For example, the general geographic location of mobile device 16 may be determined based upon, at least in part, a detected proximity to cellular network/bridge 50, via triangulation utilizing more than one cellular network/bridge, or other similar technique.

The level of granularity of the geographic location of the mobile device may vary depending upon system attributes, design criteria, and the like. For example, the position data indicative of the geographic location of mobile device 16 may include GPS determined coordinates, which may be accurate to within a couple of meters. Additionally/alternatively, the determined 100 geographic location of mobile device 16 may be a general geographic location (e.g., the position data may indicate that mobile device 16 is within a three block radius of cellular network/bridge 50). Further, the level of granularity of geographic location determined 100 by virtual tour process 10 may vary depending upon the resources (e.g., general proximity, triangulation, GPS receiver, etc.) available for determining the geographic location of the mobile device.

Upon determining 100 the geographic location of mobile device 16, virtual tour process 10 may access 102 tour information. The tour information may include information relevant to one or more landmarks associated with the determined 100 geographic location. For example, the tour information may include a listing of landmarks, historical information, bibliographic information, pictures, video, etc. Accessing 102 tour information may include accessing tour information stored on a local storage device associated with mobile device 16 (e.g., storage device 26 associated with mobile device 16). For example, virtual tour process 10 may access a library of tour information (not shown) stored on storage device 26. The library of tour information may include information relevant to specific geographic regions, etc. In one embodiment, the library of tour information for a specific region may be loaded onto storage device 26, e.g., in anticipation of a users trip to the specific region, or the like. Additionally/alternatively, accessing 102 tour information may include accessing tour information via a wireless network. For example, virtual tour process 10 may access 102 tour information from server virtual tour process 38 (e.g., via wireless communication channel 48 and network 22). In such an embodiment, virtual tour process 10 may request tour information relevant to the determined 100 geographic location of mobile device 16. In response to the request for tour information for the North End of Boston, server virtual tour process 38 may transmit relevant tour information to virtual tour process 10 on mobile device 16. As such, accessing 102 tour information may include receiving tour information from server virtual tour process 38 via a wireless network (e.g., wireless communication channel 48).

Upon accessing 102 tour information for the relevant geographic location (i.e., the corner of Hull St. and Salem St. in the foregoing example), virtual tour process 10 may render 104 the tour information for the determined 100 geographic location on mobile device 16. For example, if mobile device 16 is already proximate a landmark, virtual tour process 10 may render 104 tour information for the proximate landmark. In this manner, user 32 may utilize virtual tour process 10 to receive tour information relative to a landmark that user 32 is currently at. If, however, mobile device 16 is not at a determined 100 geographic location that is in close proximity to a landmark, virtual tour process 10 may provide a map (not shown) displaying the locations (e.g., and optionally names and/or descriptions) of landmarks in the general vicinity of the determined 100 geographic location of mobile device 16.

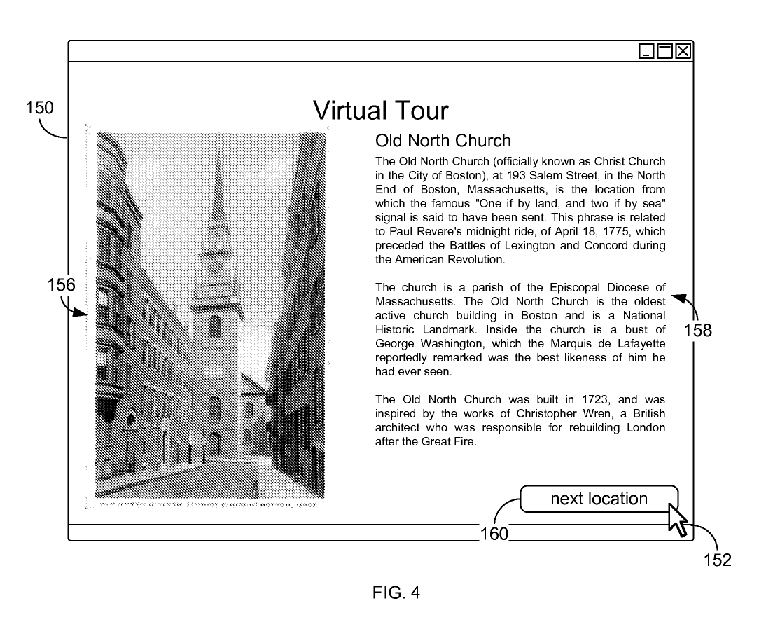

As discussed above, the tour information may include video, pictures, text, and the like. As such, rendering 104 the tour information may include providing one or more of a video output, audio output, and a text-based output. Continuing with the above-stated example in which user 32 is at the corner of Hull St. and Salem St. in Boston, which is the location of the Old North Church, and referring also to FIG. 4, based upon, at least in part, the determined 10 location of mobile device 16, virtual tour process 10 may render 104 tour information pertaining to the Old North Church in Boston. As shown in FIG. 4, virtual tour process 10 may render 104 tour information which may include, for example, picture 156 of the Old North Church, as well as text-based information 158 about the Old North Church. Additionally, while now shown, additional tour information may be included. Such additional tour information may include, for example, an audio output including narrative information about the landmark, a video output, e.g., including video information about the landmark, an video or animated tour guide providing narrative information about the landmark, or the like.

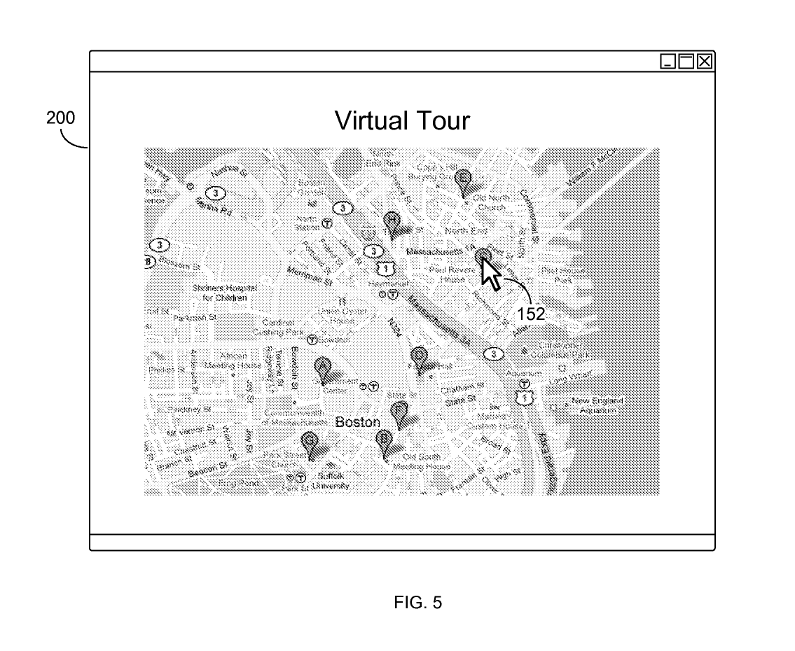

Additionally, rendering 104 the tour information may include providing 106 directions to one or more landmarks based upon, at least in part, the determined geographic location. For example, after viewing the Old North Church and consuming the tour information about the Old North Church, user 32 may which to visit another attraction. Accordingly, user 32 may select (e.g., via onscreen pointer 152, controlled by a pointing device) “next location” button 160. Referring also to FIG. 5, in response to user 32 selecting “next location button 160, virtual tour process 10 may provide map 200 indicating the presence and location of additional landmarks. User 32 may, for example, select (e.g., via onscreen pointer 152, controlled by a pointing device) one or more indicated landmarks. In response to user 32 selecting one or more indicated landmarks on map 200, virtual tour process 10 may, for example, provide additional information about the landmark, provide directions to the selected landmark, and the like.

Accordingly, in various implementations, virtual tour process 10 may provide information concerning one or more attractions and/or landmarks at a determined geographic location (e.g., a location where mobile device 16, along with user 32, may currently be located). Additionally/alternatively, virtual tour process 10 may provide a map including attractions and/or landmarks in the general vicinity (e.g., within a predetermined distance, based upon, at least in part, user preference) of the determined geographic location. Further, virtual tour process 10 may provide information concerning one or more attractions and/or landmarks of which user 32 (e.g., along with mobile device 16) may come within a predetermined distance (e.g., based upon, at least in part, user preference). Further still, virtual tour process 10 may provide a map and/or directions from a determined geographic location to one or more attractions and/or landmarks, e.g., which may, in some instances, provide a guided tour that may optionally be undertaken by user 32

While the tour information has been described herein above as relating to historical sites, this has been for the purpose of example and should not be construed as a limitation of the present disclosure. For example, the tour information may relate to any popular sight-seeing attractions or the like.

A number of implementations have been described. Nevertheless, it will be understood that various modifications may be made. Accordingly, other implementations are within the scope of the following claims.

What is claimed is:

1. A computer method comprising:
determining a geographic location of a mobile device;
accessing, by the mobile device, tour information based upon, at least in part, the determined geographic location; and
rendering, on the mobile device, the tour information based upon, at least in part, the determined geographic location.

2. The computer implemented method of claim 1, wherein accessing tour information includes accessing tour information via a wireless network.

3. The computer implemented method of claim 1, wherein accessing tour information includes accessing tour information stored on a local storage device.

4. The computer implemented method of claim 1, wherein the tour information includes information relevant to one or more landmarks associated with the determined geographic location.

5. The computer implemented method of claim 1, wherein rendering the tour information includes providing directions to one or more landmarks based upon, at least in part, the determined geographic location.

6. The computer implemented method of claim 1, wherein rendering the tour information includes providing one or more of: video output, audio output, text-based output.

7. A computer program product residing on a computer readable medium having a plurality of instructions stored thereon, which, when executed by a processor, cause the processor to perform operations comprising:
determining a geographic location of a mobile device;
accessing, by the mobile device, tour information based upon, at least in part, the determined geographic location; and
rendering, on the mobile device, the tour information based upon, at least in part, the determined geographic location.

8. The computer program product of claim 7, wherein the instructions for accessing tour information include instructions for accessing tour information via a wireless network.

9. The computer program product of claim 7, wherein the instructions for accessing tour information include instructions for accessing tour information stored on a local storage device.

10. The computer program product of claim 7, wherein the tour information includes information relevant to one or more landmarks associated with the determined geographic location.

11. The computer program product of claim 7, wherein the instructions for rendering the tour information include instructions for providing directions to one or more landmarks based upon, at least in part, the determined geographic location.

12. The computer program product of claim 7, wherein the instructions for rendering the tour information include instructions fore providing one or more of: video output, audio output, text-based output.

13. A system comprising:
a processor:
a memory coupled with the processor;
a first software module executable by the processor and the memory, the first software module configured to determine a geographic location of a mobile device;
a second software module executable by the processor and the memory, the second software module configured to access, by the mobile device, tour information based upon, at least in part, the determined geographic location; and
a third software module executable by the processor and the memory, the third software module configured to render, on the mobile device, the tour information based upon, at least in part, the determined geographic location.

14. The system of claim 13, wherein the second software module, configured to access tour information, is configured to access tour information via a wireless network.

15. The system of claim 13, wherein the second software module, configured to access tour information, is configured to access tour information stored on a local storage device.

16. The system of claim 13, wherein the tour information includes information relevant to one or more landmarks associated with the determined geographic location.

17. The system of claim 13, wherein the third software module, configured to render the tour information, is configured to provide directions to one or more landmarks based upon, at least in part, the determined geographic location.

18. The system of claim 13, wherein the third software module, configured to render the tour information, is configured to provide one or more of: video output, audio output, text-based output.
